(19) United States
(12) Patent Application Publication
(10) Pub. No.: US 2026/0302364 A1
(43) Pub. Date: Oct. 1, 2026

(54) METHOD OF MANUFACTURING SECONDARY BATTERY

(71) Applicant: HONDA MOTOR CO., LTD., Tokyo (JP)

(72) Inventors: Kizashi IWAKIRI, Saitama (JP); Fumikazu NAKAZAWA, Saitama (JP); Masahiro HOKAZONO, Saitama (JP)

(21) Appl. No.: 19/577,383

(22) Filed: Mar. 25, 2026

(30) Foreign Application Priority Data
Mar. 31, 2025 (JP) 2025-060157

(51) Int. Cl. H01M 10/0585; H01M 10/0562

(52) U.S. Cl. CPC H01M 10/0585; H01M 10/0562

(57) ABSTRACT

Provided is a method of manufacturing a secondary battery, the method being capable of accurately applying a coating in an amount necessary for protecting an end portion of an electrode laminate. The method is for manufacturing the secondary battery, the secondary battery including an electrode laminate that includes a plurality of electrode assemblies. The method includes: a laminating step including laminating a positive electrode layer, a negative electrode layer, and an electrolyte layer in a laminating direction to obtain an electrode laminate; and an elastic member forming step including forming an elastic member on an end portion of the electrode laminate in a first direction orthogonal to the laminating direction. A thickness of the elastic member in the first direction is set based on an outermost end position among end positions of the plurality of electrode assemblies in the first direction.

This application is based on and claims the benefit of priority from Japanese Patent Application No. 2025-060157, filed on 31 Mar. 2025, the content of which is incorporated herein by reference.

### BACKGROUND OF THE INVENTION

### Field of the Invention

The present invention relates to a method of manufacturing a secondary battery.

### Related Art

In recent years, research and development of secondary batteries that contribute to energy efficiency has been carried out in order to ensure many people have access to affordable, reliable, sustainable, and advanced energy. A known example of methods of manufacturing secondary batteries includes a step of pressing an electrode laminate obtained by laminating electrode layers (a positive electrode layer and a negative electrode layer) and an electrolyte layer.

The electrode laminate of the secondary battery may include a layer that extends more outward than the other layers. A technology for protecting a side surface of such an electrode laminate with a coating layer composed of resin or the like is known (for example, see Japanese Unexamined Patent Application, Publication No. 2020-004528).
Patent Document 1: Japanese Unexamined Patent Application, Publication No. 2020-004528

### SUMMARY OF THE INVENTION

During actual manufacture of secondary batteries, lamination misalignment may occur when laminating the electrode laminates or transporting the electrode laminates. When the lamination misalignment occurs, the ends of the layers in the electrode laminate are not positioned in alignment, which may make the coating layer on the ends locally have an insufficient thickness. To address this case, it is conceivable to make the protective layer to have a sufficient thickness, taking into account lamination misalignment in advance. However, in order to improve the energy density of the secondary battery, it is preferable that the thickness of the protective layer be as thin as possible.

The present invention has been made in view of the above circumstances, and an object of the present invention is to provide a method of manufacturing a secondary battery, the method being capable of accurately applying a coating in an amount necessary for protecting an end portion of an electrode laminate.
(1) A first aspect of the present invention relates to a method of manufacturing a secondary battery, the secondary battery including an electrode laminate that includes a plurality of electrode assemblies, each of the plurality of electrode assemblies including a positive electrode layer, a negative electrode layer, and an electrolyte layer disposed between the positive electrode layer and the negative electrode layer, the method including: a laminating step including laminating the positive electrode layer, the negative electrode layer, and the electrolyte layer in a laminating direction to obtain the electrode laminate; and an elastic member forming step including forming an elastic member on an end portion of the electrode laminate in a first direction orthogonal to the laminating direction. A thickness of the elastic member in the first direction is set based on an outermost end position among end positions of the plurality of electrode assemblies in the first direction.
(2) According to a second aspect, in the method described above in (1), the thickness of the elastic member in the first direction based on the outermost end position is 100 μm or more.
(3) According to a third aspect, in the method described above in (1), the thickness of the elastic member in the first direction based on the outermost end position is 1 mm or less.
(4) According to a fourth aspect, in the method described above in (1), the thickness of the elastic member in the first direction based on the outermost end position is 100 μm or more and 300 μm or less at opposite end portions of the elastic member in the laminating direction, and is 400 μm or more and 600 μm or less at a central portion of the elastic member in the laminating direction.
(5) According to a fifth aspect, in the method described above in (1), the elastic member forming step includes: a determination step including determining whether or not a degree of lamination misalignment of the electrode laminate is equal to or greater than a predetermined value; and a thickness control step including performing control to make the thickness of the elastic member in the first direction thinner than a predetermined thickness when the degree of lamination misalignment has been determined to be equal to or greater than the predetermined value in the determination step.
(6) According to a sixth aspect, in the method described above in (5), the thickness control step includes performing control to make the thickness of the elastic member in the first direction be 100 μm or more even when the degree of lamination misalignment has been determined to be equal to or greater than the predetermined value in the determination step.

The present invention can provide a method of manufacturing a secondary battery, the method being capable of accurately applying a coating in an amount necessary for protecting an end portion of an electrode laminate.

### BRIEF DESCRIPTION OF THE DRAWINGS

FIG. 1 is a cross-sectional view schematically illustrating a configuration of a secondary battery according to a first embodiment; and

FIG. 2 is a cross-sectional view schematically illustrating a configuration of a secondary battery according to a second embodiment.

### DETAILED DESCRIPTION OF THE INVENTION

### First Embodiment

### Secondary Battery

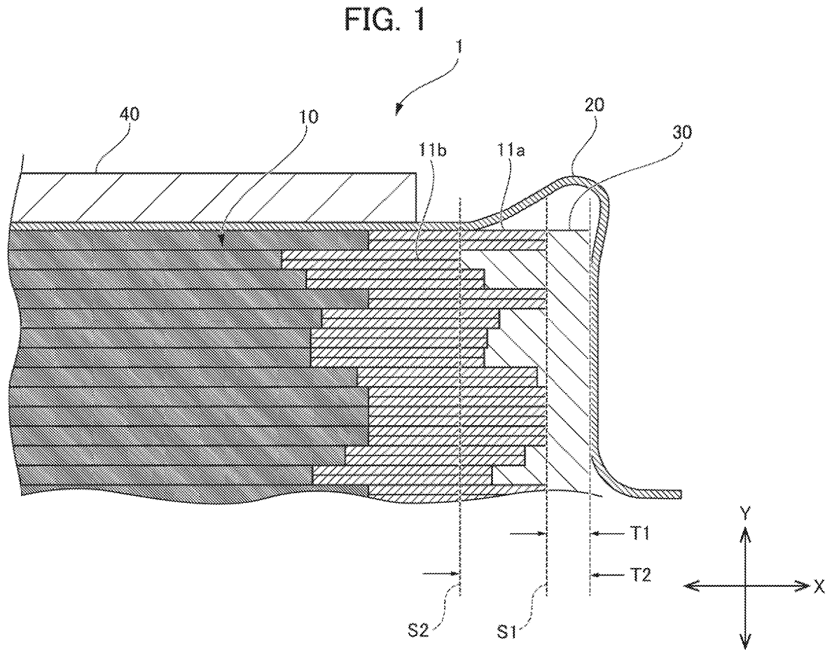

As illustrated in FIG. 1, a secondary battery 1 according to a first embodiment includes an electrode laminate 10 in which a plurality of electrode layers and a plurality of electrolyte layers are laminated. An example of the secondary battery 1 is a solid-state secondary battery that includes a solid electrolyte as an electrolyte. Examples of the solid-state secondary battery include a lithium metal secondary battery that includes lithium metal as a negative electrode active material, a lithium ion secondary battery, and the like.

### Electrode Laminate

The electrode laminate 10 includes a plurality of electrode assembles each including a positive electrode layer, a negative electrode layer, and an electrolyte layer disposed between the positive electrode layer and the negative electrode layer. In addition to the above, the electrode laminate 10 may include, for example, an intermediate layer disposed between the electrolyte layer and the negative electrode layer. The positive electrode layer includes a positive electrode current collector and a positive electrode active material layer. The negative electrode layer includes a negative electrode current collector and a negative electrode active material layer. In the electrode laminate 10, the layers are laminated in a limiting direction, which corresponds to the Y direction indicated in each figure.

The positive electrode current collector is disposed in contact with the positive electrode active material layer and has a function of collecting current from the positive electrode active material layer. The material for the positive electrode current collector is not particularly limited as long as the material is capable of collecting current from the positive electrode active material layer. Examples of the material for the positive electrode current collector include, but are not limited to, aluminum, aluminum alloys, stainless steel, nickel, iron, and titanium. Among these, at least one selected from the group consisting of aluminum, aluminum alloys, and stainless steel is preferred.

Examples of the shape of the positive electrode current collector include, but are not limited to, a foil shape and a plate shape. The positive electrode current collector may have any thickness without particular limitation, and the thickness may be the same as that of positive electrode current collectors included in positive electrodes of general secondary batteries. The thickness of the positive electrode current collector of the present embodiment may be, for example, in a range of 0.1 μm or more and 1 mm or less.

The positive electrode current collector of the present embodiment has a substantially rectangular shape when viewed in the laminating direction, and any one of the sides thereof is extended in a current collector extending direction to be electrically connected to a positive electrode tab lead. In other words, the current collector extending direction is orthogonal to the one of the sides of the rectangular positive electrode current collector.

The positive electrode active material layer contains at least a positive electrode active material. The positive electrode active material contained in the positive electrode active material layer is not particularly limited as long as the material can be used for positive electrode active material layers of general secondary batteries. In the case of a lithium ion battery, examples of the positive electrode active material include, but are not limited to, layered active materials containing lithium, spinel-type active materials, and olivine-type active materials. Specific examples of the positive electrode active material include, but are not limited to, lithium cobalt oxide (LiCoO₂), lithium nickel oxide (LiNiO₂), LiNiₚMn_{q}CoᵣO₂ (p+q+r=1), LiNiₚAl_{q}CoᵣO₂ (p+q+r=1), lithium manganese oxide (LiMn₂O₄), heteroelement-substituted Li—Mn spinel represented as Li₁₊ₓMn_{2-x-y}M_{y}O₄ (x+y=2; M is at least one selected from Al, Mg, Co, Fe, Ni, or Zn), lithium titanate (oxide containing Li or Ti), and lithium metal phosphate (LiMPO₄, M is at least one selected from Fe, Mn, Co, or Ni).

The positive electrode active material layer may optionally contain a solid electrolyte described later in order to improve lithium ion conductivity. Additionally or alternatively, the positive electrode active material layer may optionally contain a binder, a conductive additive, and the like.

The positive electrode active material layer may have any thickness without particular limitation, and the thickness can be appropriately set according to the desired battery performance. The thickness of the positive electrode layer may be, for example, in a range of 0.1 μm or more and 1 mm or less.

An insulating material may be disposed on an end portion of each positive electrode layer orthogonal to the laminating direction. By disposing the insulating material on the end portion of each positive electrode layer, when negative electrode current collector tabs extending from the negative electrode current collectors of respective cell structures are gathered and electrically connected to a tab lead, contact between the negative electrode current collector tabs and the end portions of the positive electrodes due to bend of the negative electrode current collector tabs can be avoided, thereby enabling reduction or elimination of the likelihood of a short circuit. Furthermore, cracking due to a change in the volume associated with repeated charge and discharge can be suppressed, thereby enabling reduction or elimination of the likelihood of a short circuit due to cracking.

The insulating material may have any shape without particular limitation as long as the insulating material is disposed on the end portion of each positive electrode layer. The insulating material may have any size without particular limitation, and it is simply required for the insulating material to be in contact with part or the entirety of the end surface of the positive electrode layer.

The material for the insulating material is not particularly limited as long as the material develops insulating properties, and is simply required to be a so-called insulator other than semiconductors and conductors. The material for the insulating material can be appropriately selected according to the characteristics to be added, and examples thereof include insulating resins.

The electrolyte layer is disposed between the positive electrode layer and the negative electrode layer. In a case where the electrolyte layer is a solid electrolyte layer, the electrolyte layer contains a solid electrolyte. Instead of the electrolyte layer, a separator impregnated with an electrolytic solution may be used as the electrolyte layer of the present invention.

The solid electrolyte is not particularly limited as long as the solid electrolyte has ion conductivity and insulating properties. Examples of the solid electrolyte include, but are not limited to, inorganic solid electrolytes such as sulfide solid electrolyte materials, oxide solid electrolyte materials, halide solid electrolytes, and lithium-containing salts; polymer solid electrolytes such as polyethylene oxide; and gel solid electrolytes containing a lithium-containing salt or a lithium ion-conductive ionic liquid. Among these, the sulfide solid electrolyte materials are preferred because they have high lithium ion-conductivity and exhibit good structure formability and interfacial bonding properties when pressed. The solid electrolyte layer may optionally contain a binder.

The negative electrode current collector is disposed in contact with the negative electrode active material layer and has a function of collecting current from the negative electrode active material layer. The material for the negative electrode current collector is not particularly limited as long as the material is capable of collecting current from the negative electrode active material layer. Examples of the material include, but are not limited to, a metal containing at least one metal element selected from the group consisting of silver, palladium, gold, platinum, aluminum, copper, and nickel, an alloy such as stainless steel, and a non-metal such as carbon (C).

The negative electrode current collector may have any shape without particular limitation, and examples thereof include, but are not limited to, a foil shape, a plate shape, a mesh shape, a nonwoven fabric shape, and a foamed shape. The negative electrode current collector may have, on a surface thereof, a carbon layer or the like or may have a roughened surface in order to improve adhesion to the negative electrode active material layer.

The negative electrode current collector may have any thickness without particular limitation, and the thickness may be the same as that of negative electrode current collectors included in negative electrodes of general secondary batteries. The thickness of the negative electrode current collector may be, for example, in a range of 0.1 μm or more and 1 mm or less.

The negative electrode active material layer contains a negative electrode active material that exchanges lithium ions and electrons. The negative electrode active material contained in the negative electrode layer is not particularly limited as long as the material can be used in negative electrode layers of general secondary batteries. Examples of the negative electrode active material include, but are not limited to, silicon-based active materials such as silicon and silicon alloys, carbon-based active materials such as graphite and hard carbon, various oxide-based active materials such as lithium titanate, and lithium-based active materials such as metal lithium and lithium alloys. As the negative electrode active material, one of these materials may be used alone or two or more thereof may be used in combination.

The negative electrode active material layer may optionally contain the aforementioned solid electrolyte in order to improve ion conductivity. The negative electrode active material layer may optionally contain a binder, a conductive additive, and the like. These substances may be the same as those generally used in secondary batteries.

The negative electrode layer may have any thickness without particular limitation, and the thickness can be appropriately set in accordance with desired battery performance. The thickness of the negative electrode layer may be, for example, in a range of 0.1 μm or more and 1 mm or less.

The secondary battery 1 may include an intermediate layer. For example, in a case where the secondary battery 1 is a lithium metal battery including lithium metal or a lithium alloy as the negative electrode active material, the intermediate layer can be disposed between the solid electrolyte layer and the negative electrode layer as a layer having electronic conductivity and ion conductivity.

In FIG. 1, each of electrode layers 11a and 11b is a specific layer in an electrode assembly including one positive electrode layer, one electrolyte layer, and one negative electrode layer, and has an end located at the outermost position in the electrode laminate. These layers are, for example, positive electrode layers, and the positive electrode layers may have the above-described insulating material on their end portions orthogonal to the laminating direction. As illustrated in FIG. 1, although the electrode layers 11a and 11b are of the same type, their ends are not aligned and are located at different positions. The electrode layer 11a is an electrode layer whose end position S1 is at the outermost position among the plurality of electrode layers. The electrode layer 11b is an electrode layer whose end position S2 is at the innermost position among the plurality of electrode layers. Such misalignment can be caused, for example, during the manufacturing process of the secondary battery 1, such as when laminating or transporting the electrode laminate 10, and is difficult to completely avoid.

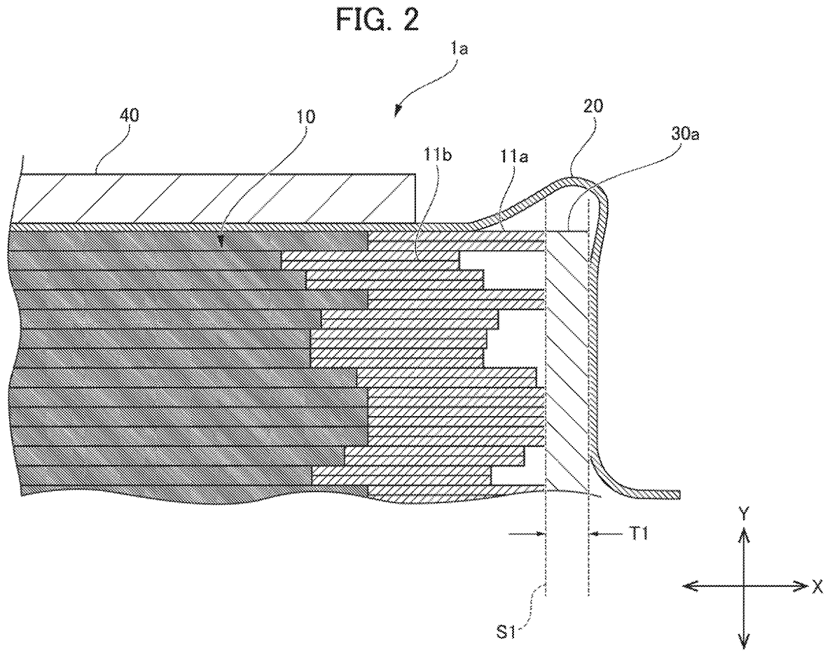

In FIGS. 1 and 2, the misalignment is emphasized for ease of understanding the state in which the end positions of the electrode layers 11a and 11b differ from each other. Therefore, the thicknesses of the electrode layers 11a and 11b in FIGS. 1 and 2 and the degree of misalignment that can occur do not reflect actual magnitudes.

### Elastic Member

An elastic member 30 is disposed on the end portions of the electrode laminate 10 in a first direction (X direction in each figure) that is orthogonal to the laminating direction (Y direction in each figure) of the electrode laminate 10. The first direction orthogonal to the laminating direction is preferably orthogonal to a current collector extension direction in which the current collectors are extended, from the viewpoint of ease of formation of the elastic member 30. The first direction may be the current collector extension direction.

The elastic member 30 is a layer having insulating properties and is composed of, for example, a resin material. The thickness T1 of the elastic member 30 in the first direction is a thickness based on the end position S1 (a thickness from the end position S1 to an outermost position in the first direction). In FIG. 1, the thickness T1 is substantially uniform regardless of a position in the laminating direction. This makes it possible to disperse force applied to the electrode laminate 10 in an end direction (first direction), and thus the electrode laminate 10 can be satisfactorily protected. The thickness T1 is preferably 100 μm or more. The thickness T1 is preferably 1 mm or less. This makes it possible to satisfactorily protect the end surface of the electrode laminate 10 and improve energy density of the secondary battery 1.

The elastic member 30 is not limited to a configuration in which the thickness T1 in the first direction is substantially uniform as illustrated in FIG. 1. For example, the elastic member 30 may have a C-chamfered or R-chamfered corner portion at an end that is not in contact with the electrode layers of the electrode laminate 10. By providing C- or R-chamfer at the corner portion, partial contact of the end portion can be prevented, and robustness against lamination misalignment can be improved. Additionally or alternatively, the elastic member 30 may be formed such that the thickness T1 is thinner at the opposite end portions of the electrode laminate 10 in the laminating direction than at a central portion. In this case, the thickness T1 of the elastic member 30 is preferably 100 μm or more and 300 μm or less at the opposite end portions in the laminating direction, and is preferably 400 μm or more and 600 μm or less at the central portion in the laminating direction. The elastic member 30 can be easily formed into this shape in an elastic member forming step described later.

In the present embodiment, the elastic member 30 is disposed in contact with the end portion of at least one of the electrode layers in the first direction, and occupies a space adjacent to end portions and lamination surfaces of other electrode layers (e.g., negative electrode layers) that are located inward with respect to the end portion of the at least one electrode layer in the first direction. Due to this configuration, local stress concentration can be reduced when force is applied to the secondary battery 1 in the end direction (first direction), thereby making it possible to satisfactorily protect the electrode laminate 10. In the present embodiment, “occupy/ies a space(s)” means a state in which the elastic member 30 is present in, for example, 80% or more of the space(s).

Although the elastic member 30 is disposed at one end portion of the electrode laminate 10 in the first direction in FIG. 1, it is preferable to dispose the elastic member 30 at the other end portion (not shown) in the first direction of the electrode laminate 10 in the same manner.

The elastic member 30 preferably has, for example, a Young's modulus of 0.1 MPa or greater and 500 MPa or less. The elastic member 30 is preferably composed of a material whose Young's modulus decreases as temperature increases from −40° C. to 100° C., and preferably has a Young's modulus of 0.1 MPa or greater and 40 MPa or less at 25° C.

The elastic member 30 is formed by, for example, applying and curing a resin composition. The resin composition may be appropriately selected from UV-curable resin compositions, thermosetting resin compositions, and the like.

The electrode laminate 10 and the elastic member 30 are accommodated in exterior covering 20. The exterior covering 20 is composed of, for example, a laminate film. The laminate film includes a metal layer and a resin layer, and encloses the electrode laminate 10 and the elastic member 30 with one or more films. In a state in which the laminate film has the electrode laminate 10 and the elastic member 30 placed therein, portions of a surface of the laminate film are brought into contact with, and welded to, each other, thereby forming a sealing portion. The sealing portion is disposed, for example, at a substantially central portion in the laminating direction of the electrode laminate 10.

A buffer material 40 is provided on the exterior covering 20 at a position corresponding to an end portion of the electrode laminate 10 in the laminating direction. The buffer material 40 is displaceable in response to expansion and contraction of the electrode laminate 10 associated with charge and discharge of the secondary battery 1, and has a function of uniformizing a surface pressure applied to the electrode laminate 10. The buffer material 40 is composed of, for example, rubber, elastomer, stretchable resin, or the like.

The secondary battery 1 may have a configuration other than that described above, and may include, for example, tab leads to which current collectors are electrically connected. Further, a plurality of the secondary batteries 1 may be modularized into a secondary battery module. In this case, a surface pressure may be applied to the electrode laminate 10 via the buffer material 40 by a restraining member such as a bind bar. Furthermore, a cooling device for cooling the secondary battery 1 may be provided.

### Method of Manufacturing Secondary Battery

A method of manufacturing a secondary battery according to the present embodiment includes a laminating step of laminating electrode layers and electrolyte layers to obtain an electrode laminate, and an elastic member forming step of forming an elastic member on an end portion of the electrode laminate in a first direction orthogonal to the laminating direction of the electrode laminate.

The laminating step includes a step of forming the electrode layers and electrolyte layers. The step of forming the electrode layers and electrolyte layers is not limited to any particular step, and a known step can be employed. A non-limiting example of the method of forming the electrode layers includes applying a slurry containing an electrode active material on a current collector and drying the slurry. A non-limiting example of the method of forming the electrolyte layers includes applying a slurry containing a solid electrolyte on a substrate and drying the slurry. The electrode layers and electrolyte layers formed by the above-described manners are laminated together, and an insulating material is formed on the peripheral edge of each positive electrode current collector as necessary, thereby producing the electrode laminate 10. The laminating step may include a step of pressing and integrating the electrode laminate 10. In a case of using a separator impregnated with electrolyte solution instead of the electrolyte layer, after the formation of the electrode laminate in which the separator is disposed between the electrode layers, the separator may be impregnated with the electrolyte solution.

The elastic member forming step is a step of forming the elastic member 30 on an end portion in the first direction of the electrode laminate 10 obtained in the laminating step. The elastic member forming step includes, first, placing the electrode laminate 10 such that the side on which the elastic member 30 is to be formed is oriented with the first direction coincident with the vertical direction. Next, a known coating apparatus such as a dispenser is filled with a coating (resin composition) for forming the elastic member, and the coating is applied from the coating apparatus to the end portion in the first direction of the electrode laminate 10. At this time, the application amount of the coating is set such that the elastic member 30 will have a predetermined thickness (e.g., 100 μm or more and 1 mm or less) in the first direction. The predetermined thickness is set based on the outermost end position S1 among the end positions of the plurality of electrode layers in the first direction.

If the thickness of the elastic member 30 in the first direction is set based on the innermost end position S2 among the end positions of the plurality of electrode layers in the first direction (thickness T2 in FIG. 1), depending on the degree of variation in the end positions in the first direction of the plurality of electrode layers, the elastic member 30 may have an insufficient thickness in the first direction. For example, if the thickness T2 in FIG. 1 is set to a thickness equivalent to the thickness T1 in FIG. 1, some of the plurality of electrode layers will have their end portions in the first direction exposed without being covered by the elastic member 30. In this case, when stress is applied to the secondary battery 1 in the first direction, the stress may concentrate on the exposed end portions of the electrode layers, and the electrode layers may be damaged. Setting the thickness of the elastic member 30 in the first direction based on the end position S1 makes it possible to reliably cover the end portions of the plurality of electrode layers with the elastic member 30. In addition, the thickness of the elastic member 30 for protecting the end portions of the plurality of electrode layers can be reliably ensured.

The elastic member forming step includes, after applying the coating to the end portion in the first direction of the electrode laminate 10, curing the coating to form the elastic member 30. The coating can be cured by a method arbitrarily selected according to the type of coating, such as light irradiation, heating, drying, or the like. The curing conditions can be arbitrarily set without particular limitation. After forming the elastic member 30 on the one end portion in the first direction of the electrode laminate 10, the elastic member 30 may be formed on the other end portion in the first direction of the electrode laminate 10 by the same or similar step.

The elastic member forming step preferably includes a determination step of determining whether or not a degree of lamination misalignment of the electrode laminate 10 is equal to or greater than a predetermined degree, and a thickness control step of performing control to make the thickness of the elastic member 30 in the first direction thinner than a predetermined thickness when the degree of lamination misalignment has been determined to be equal to or greater than the predetermined degree in the determination step.

The determination step is performed, for example, according to the following procedure. First, the electrode laminate 10 is placed such that the side on which the elastic member 30 is to be formed is oriented with the first direction coincident with the vertical direction. Next, the distance between a reference position and the end position S1 of the electrode laminate 10 is measured using a known distance measuring sensor or the like. The measurement is performed by measuring the distance in the X direction in an X-Y cross section and an X-Z cross section in the figures. The reference position may be the position of a nozzle. At this time, the distance between a reference surface on which the electrode laminate 10 is placed and the nozzle for applying the coating may be set to a predetermined distance in advance. In the measurement of the X-Y cross section, a difference between the height of an application start side and the height of an application end side is also measured. Next, the distance is regarded as a degree of lamination misalignment, and it is determined whether or not the distance is equal to or greater than a predetermined value. Because the electrode assemblies constituting the electrode laminate 10 have a certain length in the X direction, the distance can be approximately regarded as the degree of lamination misalignment.

The thickness control step includes applying the coating to the end portion of the electrode laminate 10 and controlling the thickness of the elastic member 30. In the thickness control step, when applying the coating, the height of the nozzle is controlled such that the distance between the nozzle and the end position S1 of the electrode laminate 10 is substantially constant, based on the results of measurement of the X-Y cross section and the X-Z cross section. This prevents the nozzle and the electrode laminate 10 from coming into contact with each other. In a case where the degree of lamination misalignment has been determined to be equal to or greater than the predetermined value in the determination step, for example, the application amount of the coating is controlled such that the thickness of the elastic member 30 in the first direction is controlled and made to be thinner than the predetermined thickness. Even in the case where the degree of lamination misalignment has been determined to be equal to or greater than the predetermined value in the determination step, the thickness of the elastic member 30 in the first direction is preferably controlled amendment set to 100 μm or more in the thickness control step. The above-described thickness of the elastic member 30 in the first direction means the thickness of the thinnest portion in a case where the thickness of the elastic member 30 in the first direction is not uniform.

All or part of the determination step and thickness control step described above may be implemented by a processor such as a CPU according to a program in which the control contents are described. The processor and a storage device such as a ROM or the like may be incorporated in a secondary battery manufacturing apparatus, or may be incorporated in an information processing device capable of communicating with the manufacturing apparatus. This configuration is an example for implementing the determination step and thickness control step described above, and the features of the present invention are not limited to the foregoing.

The method of manufacturing a secondary battery according to the present embodiment may include a housing step of housing the electrode laminate 10 having the elastic member 30 formed thereon in the exterior covering 20 after the elastic member forming step. The housing step may include, for example, wrapping the electrode laminate 10 with a laminate film and sealing it in a vacuum state.

The method of manufacturing a secondary battery according to the present embodiment may include an optional step in addition to the steps described above. For example, it may include a step of transporting the electrode laminate 10 between the steps. The method of manufacturing a secondary battery according to the present embodiment can form the elastic member 30 in a manner allowing lamination misalignment. Therefore, even if lamination misalignment is caused due to a step of transporting the electrode laminate 10 by a belt conveyor or the like, the end portion of the electrode laminate 10 can be reliably protected by the elastic member 30.

Next, a secondary battery according to another embodiment of the present invention will be described. In the following description, components similar to those of the first embodiment are denoted by the same reference numerals in the drawings, and description thereof may be omitted.

### Second Embodiment

A secondary battery 1a according to a second embodiment differs from the secondary battery of the first embodiment only in the configuration of an elastic member 30a. The elastic member 30a is provided in contact with the end portion of at least one of the electrode layers. The elastic member 30a does not occupy a space adjacent to the end portions and lamination surfaces of other electrode layers (e.g., negative electrode layers) that are located inward with respect to the end portion of the at least one electrode layer in the first direction. In the present embodiment, “not occupy a space(s)” includes a state in which the elastic member 30a does not at all present in the space. In addition to the above, it includes a state in which a part of the elastic member 30a occupies the space, but the elastic member 30a is absent in at least a part of the space. In the present embodiment, the elastic member 30a may be absent in half or less of the space.

For the elastic member 30a, a thickness T1 in the first direction is set as a thickness based on the end position S1 (the thickness from the end position S1 to the outermost side in the first direction), similarly to the first embodiment.

In a method of manufacturing the secondary battery 1a, an elastic member forming step may include disposing a resin material (a cured resin composition) having a predetermined thickness and a predetermined shape as the elastic member 30a in contact with an end portion of the electrode laminate 10. In this case, the thickness and shape of the elastic member 30a can be easily achieved as desired, thereby facilitating the manufacture of the secondary battery 1a.

In the foregoing, preferred embodiments of the present invention have been described above. It should be noted that the present invention is not limited to the embodiments described above, and can be appropriately modified within a range that does not impair the effects of the present invention.

### EXPLANATION OF REFERENCE NUMERALS

1, 1a: Secondary battery
10: Electrode laminate
11a, 11b: Electrode layer
S1: Outermost end position
Y: Laminating direction
X: First direction

What is claimed is:

1. A method of manufacturing a secondary battery, the secondary battery comprising an electrode laminate that includes a plurality of electrode assemblies, each of the plurality of electrode assemblies including a positive electrode layer, a negative electrode layer, and an electrolyte layer disposed between the positive electrode layer and the negative electrode layer, the method comprising:
a laminating step including laminating the positive electrode layer, the negative electrode layer, and the electrolyte layer in a laminating direction to obtain the electrode laminate; and
an elastic member forming step including forming an elastic member on an end portion of the electrode laminate in a first direction orthogonal to the laminating direction,
wherein
a thickness of the elastic member in the first direction is set based on an outermost end position among end positions of the plurality of electrode assemblies in the first direction.

2. The method according to claim 1, wherein the thickness of the elastic member in the first direction based on the outermost end position is 100 μm or more.

3. The method according to claim 1, wherein the thickness of the elastic member in the first direction based on the outermost end position is 1 mm or less.

4. The method according to claim 1, wherein the thickness of the elastic member in the first direction based on the outermost end position is 100 μm or more and 300 μm or less at opposite end portions of the elastic member in the laminating direction, and is 400 μm or more and 600 μm or less at a central portion of the elastic member in the laminating direction.

5. The method according to claim 1, wherein the elastic member forming step comprises:
a determination step including determining whether or not a degree of lamination misalignment of the electrode laminate is equal to or greater than a predetermined value; and
a thickness control step including performing control to make the thickness of the elastic member in the first direction thinner than a predetermined thickness when the degree of lamination misalignment has been determined to be equal to or greater than the predetermined value in the determination step.

6. The method according to claim 5, wherein the thickness control step includes performing control to make the thickness of the elastic member in the first direction be 100 μm or more even when the degree of lamination misalignment has been determined to be equal to or greater than the predetermined value in the determination step.
